(19) United States
(12) Patent Application Publication
(10) Pub. No.: US 2013/0232022 A1
(43) Pub. Date: Sep. 5, 2013

(54) SYSTEM AND METHOD FOR RATING ONLINE OFFERED INFORMATION

(71) Applicant: Hermann GEUPEL, Munich (DE)

(72) Inventor: Hermann GEUPEL, Munich (DE)

(21) Appl. No.: 13/412,326

(22) Filed: Mar. 5, 2012

(51) Int. Cl. G06Q 30/06

(52) U.S. Cl. 705/26.1

(57) ABSTRACT

A system for rating online offered information that includes central control unit, at least one client unit of at least one seller, and a knowledge (web) site, and is configured to receive via the knowledge site a question stated by a buyer, and to post the question on the knowledge site and optionally on the at least one client unit of the at least one seller, the at least one client unit is configured to analyse a drafted answer of the seller by use of data mining prior to publication of the answer and to send its analysis result to the central control unit which is further configured to process the analysis result and to communicate the processed analysis result to the buyer and to publish the answer to the buyer in case that the buyer accepts the answer based on the processed analysis result.

### TECHNICAL FIELD

The present invention refers to a system and a respective method for rating online offered information.

Today, the internet is not only used to buy computing power, but also mental performance. The latter is called crowdsourcing. The crowdsourcing services that are known to the inventor may be divided into two main groups. The first group is represented by simple services that are paid with a very low amount prior to their respective provision. Reference is made, for example, to www.mturk.com, www.ciao.co.uk and http://de.toluna.com. The second group may be represented by more creative services that are paid with a high amount after their respective provision, but just to the selected winner. Reference is made, for example, to www.tchibo-ideas.de and www.innocentive.com.

The above-mentioned two extremes reflect the dilemma of buying information. The value of a certain information is highly subjective and can be valued from a buyer just after disclosure of the respective information. But in that moment, the merchandise information cannot be withdrawn anymore by a respective seller for price negotiation purpose. If a price for an information is set prior to its disclosure, the respective buyer bears the risk of poor delivery. If the price for an information is set after its respective disclosure, the respective seller bears the risk of low payment.

Within traditional consulting a consultant as negotiator tries to build up trust at a respective buyer and then agrees on a price for an offered information pri- or to delivery. In the context of crowdsourcing via the Internet, such practice is not readily feasible.

Additionally to the above-described dilemma of pricing, there is also a certain requirement of confidentiality when information is bought. By posing a question, the respective buyer is disclosing his problem and by answering on a question, the respective seller is presenting his knowhow. Conventionally, such request for confidentiality is covered by a personal trust relation. In the Internet, both parties may satisfy their need for confidentiality by using pseudonyms. If they additionally take care not to indirectly reveal their identity by details in their question or answer, they do not reveal anything personal. The use of a pseudonym means an advantage in confidentiality, but a further disadvantage in mutual trust.

In view of the prior art, it was an object of the present invention to provide a system for consulting a buyer of an online information about his expected satisfaction with the offered, not yet disclosed information.

The present invention provides a system for rating online offered information. The claimed system comprises at least a central control unit, at least one client unit of at least one seller and a knowledge portal. The central control unit is configured to receive via the knowledge portal a question stated by a buyer and to post the question on the knowledge portal and optionally on the at least one client unit of the at least one seller. The at least one client unit is configured to analyse a drafted answer of the seller by use of data mining prior to publication of the answer and to send its analysis result to the central control unit which is further configured to process the analysis result and to communicate the processed analysis result to the buyer and to publish the answer to the buyer in case that the buyer accepts the answer based on the processed analysis result.

The information that is exchanged between seller and buyer does not necessarily appear in the form of question and answer, but also in the form of a task and its completion or other forms of request and provisioning of information. In the following all forms of requests from the buyer are called “question” and all forms of provisioning of information from the seller are called “answer”.

According to a possible embodiment of the claimed system, the knowledge portal is a website hosted on at least one webserver accessible via the Internet or via a private local area network through an internet address.

Furthermore, it is possible that the knowledge portal requests from the buyer to state the question, to assign the question to one or more selectable subject fields or to a new one and to set a basis price for an answer.

According to a further embodiment of the proposed system, the system comprises a database used to store seller, buyer and buyer's question profiles, respectively. The database is accessible by the central control unit. The seller and buyer profiles can always be updated, respectively, by the central control unit.

According to a further embodiment the inventive system is not only assessing the seller and the buyer of the traded information by the central control unit that utilizes and actualizes a seller profile and a buyer profile which are stored in the database, but is also assessing and analysing by using data mining the offered information itself which is to be entered into the client unit as a drafted answer in advance before forwarding and presenting the information to the respective buyer.

According to a further embodiment of the proposed system, the client unit checks, for example, a syntax as, for example, a number of sentences, a number of words and a number of special terms like weblinks.

According to a further embodiment of the proposed system, the client unit checks the content of the drafted answer as, for example, words and phrases that are desired (white list) and/or not desired (black list) by the buyer, words and phrases that other sellers use in their answers to the same question, words and phrases that have been used in already assessed answers within the same special field, and words and phrases that are available in the Internet within the same special field.

According to a further embodiment of the proposed system, the client unit checks a chronology, that means a number of entered and maybe deleted words mapped over the time.

According to a further embodiment of the proposed system, a match of the seller's profile to a buyer's question profile is utilized for processing the analysis result.

The buyer's question profile indicates, for example, a set of subject fields in which a seller should comprise knowhow in order to be able to satisfyingly answer the question. The indicated subject fields may also be weighted in relation to each other. The buyer's question profile may additionally indicate the buyer's demand in behavioral attitudes of a potential seller, for example, the seller's liability.

The seller profile shows the seller's knowhow in certain subject fields according to the ratings of previous buyers. The seller profile may also include a seller's behavior, for example, in regards to a seller's liability.

In contrast thereto, the buyer profile characterizes the buyer with respect, for example, to his motivation/behavior about a performance rating which is to be given for the seller after receiving an offered answer of this seller. The buyer profile may, for example, indicate whether the buyer has missed to rate a seller. The buyer profile may also store all the ratings that the buyer has previously given.

One person may have a buyer and seller profile, characterizing him in two different roles in the inventive system.

According to a further embodiment of the proposed system, the match of the seller's profile to a buyer's question profile is calculated by weighting according to the buyer's question profile the seller's profiled knowhow in the regarded subject fields and summing them up.

According to a further embodiment of the proposed system, the knowledge portal enables setting a time limit for the answer of the at least one seller.

According to another embodiment of the proposed system, the knowledge portal enables a function that reduces a basis price for the answer which is pregiven by the buyer as a function of time.

Furthermore, it is possible that the knowledge portal enables choosing or creating terms that are desired in the answer as a white list and/or that are not desired in the answer as a black list.

Furthermore, it is possible according to a further embodiment of the proposed system that the knowledge portal enables specifying a group of users that can view the question and offer an answer. That means that it is possible to disclose the question to a plurality of sellers. It is also possible to disclose the question only to a specific group of sellers. Generally, each seller has access to or is connected with a client unit which is configured to receive a drafted answer of a respective seller, to analyse the drafted answer by use of data mining prior to any publication of the answer and to send the analysis result to the central control unit.

Generally, sellers who want to participate in answering questions posed at the system, particularly at the knowledge portal, are registered with the system and respective seller profiles are stored in the database of the system. Generally, the same applies to buyers who want to pose questions in any specific subject field at the knowledge portal. Respective buyer profiles are also stored in the database of the system.

If the seller answers prior to his registration at the proposed system, it is possible that the central control unit reads out an ID of the seller's hardware, for example, a UUID if the seller uses an Apple device, and assigns a temporary and anonymous ID to the seller. A later satisfaction feedback from the buyer can be assigned to that ID and credited after registration of the seller to the system. Thereby, the seller is enabled to immediately participate and register just after he has gathered positive experience on the system, i.e. the platform.

According to a further embodiment of the proposed system, the client unit is further configured to provide the at least one seller a chance to accept the buyer's basis price and/or to quote higher or lower. The price accepted or accordingly changed by the seller is also introduced as further decision criterion into the processed analysis result. That means that processing the data mining analysis result comprises inter alia accounting for the price requested by the seller.

The processed analysis result can be gained by calculating an expected satisfaction level of the buyer by taking into account the analysis result. Further, as already mentioned above, the match of the buyer's question profile and the seller profile and the price requested by the seller can be included in the processed analysis result.

In case that the buyer wants to accept the answer of the at least one seller, the central control unit may be configured to initiate a money transfer from buyer to seller prior to publishing the answer to the buyer.

Furthermore, it is possible that the central control unit provides a short questionnaire to the buyer that queries a final buyer's assessment of the answer pubis lished to the buyer.

According to a further embodiment of the proposed system, the central control unit is further configured to update respective seller's and buyer's profiles in the database.

An impact of the buyer's rating on the seller's profile depends on the buyer's profile. If the buyer in average rates sellers higher or lower than other buyers do for the same sellers, then the buyer is regarded to be in general more generous or stingy than the average. The buyer's rating of a seller is normalized accordingly before the seller's profile is refined by that rating.

A buyer's rating may also be weighted by a ratio of a spent money amount for the regarded seller's answer to a money amount that the regarded seller has totally gathered, before the seller profile is updated in the regarded subject fields.

The present invention further refers to a method for rating online offered information, wherein the method comprises at least the following steps:

receiving a question stated by a buyer via a knowledge portal;

posting the question on the knowledge portal and optionally on at least one client unit of at least one seller;

analyzing a drafted answer of the at least one seller at the at least one client unit by using data mining prior to publishing the answer;

processing the analysis result;

communicating the processed analysis result to the buyer; and

publishing the answer to the buyer in case that the buyer accepts the answer based on the processed analysis result.

The proposed method can be performed by using the claimed system or any embodiment of the system as described before.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram of an example system for rating online offered information.

FIG. 2 is a block diagram illustrating an example process for buying an information supported by an embodiment of the claimed method.

FIG. 3 depicts an example directed graph describing an example correlation of subject fields.

FIG. 4 is a block diagram of an example process of profile building and enhancement.

FIG. 5 is a graph illustrating an example valuation of an amount of buzz words.

FIG. 6 is a diagram illustrating an example valuation of a length of an answer.

FIG. 7 depicts an example diagram describing an example process of calculating an expected satisfaction and stability of a prediction.

FIG. 8 illustrates a possible computer system upon which an embodiment of the present invention may be implemented.

### DETAILED DESCRIPTION OF THE INVENTION

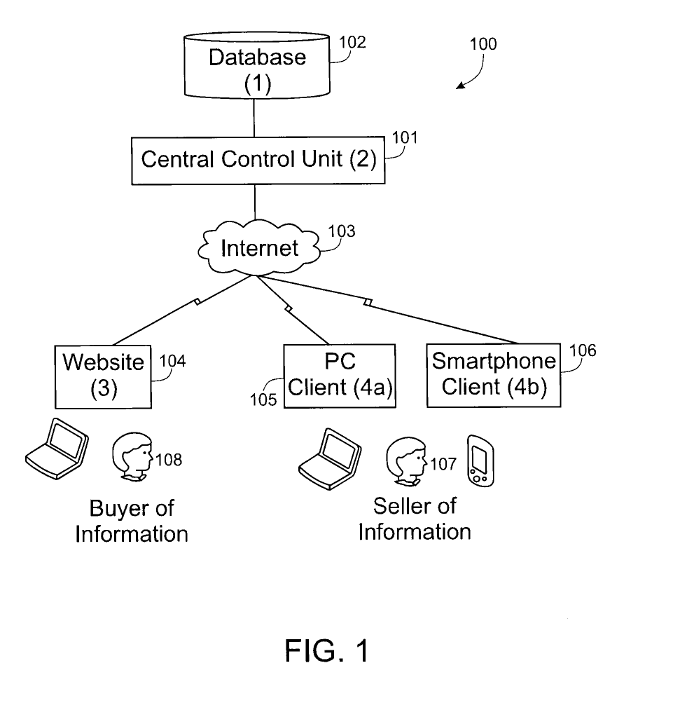

FIG. 1 is a block diagram of an example system 100 for rating an online offered information.

The example system 100 comprises a central control unit 101. The central control unit 101 is connected with a database 102 and further with the Internet 103. Via the Internet 103 a website 104 is accessible, the website being hosted on at least one webserver. The website 104 represents a knowledge portal. The shown system 100 further comprises a client unit 105 and a further client unit 106 of a seller 107. The client unit 105 is installed on a PC and the client unit 106 is installed on a smartphone. When the system is operated for rating an online offered information, the process can be described as follows. The website 104 requests from a buyer 108 to state his question, to assign the question to one or more selectable subject fields or to a new subject field and to set a basis price per answer as a guideline for a seller's price offer. The website 104 may further enable setting a time limit for the answer. Furthermore, it is possible that the website 104 installs a function that reduces the basis price as a function of time. Furthermore, it may be possible that a buyer chooses or creates via the website 104 terms that are desired in the answer in form of a white list or terms that are not desired in the answer as a black list. The website 104 may further enable specifying a group of users, i.e. sellers, that can view the question and/or offer their respective answer.

The central control unit 101 posts the question on one or both of the client units 105 or 106 of the registered seller 107 and, additionally, on the website 104 if the group of recipients is not limited. If a seller answers prior to his registration at the system 100, optionally, the control unit 101 reads out the ID of the seller's hardware, for example, a UUID if the seller uses an Apple device, and assigns a temporary and anonymous ID to the seller. A later satisfaction feedback from the respective buyer, i.e. buyer 108, can be assigned to that ID and credited after registration of the respective seller. That enables sellers to immediately participate and register just after they have gathered positive experience on the platform.

The software clients 105 and 106 analyse, respectively, a drafted answer given by the respective seller 107 by means of data mining prior to the publication of the drafted answer to the buyer 108 if the respective seller 107 agrees on it. The client units 105, 106 further provide the seller 107 the chance to accept the buyer's basis price or to quote a higher or lower. The client units 105, 106 further send the respective analysis result to the central control unit 101.

The central control unit 101 then processes the analysis result by calculating the buyer's expected satisfaction level taking into account the result of the analysis of the drafted answer. The central control unit 101 further communicates the expected satisfaction level as the processed analysis result and the seller's price quote via website 104 to the buyer 108. The central control unit 101 requests the buyer 108 whether he wants to accept the offered answer. If yes, the central control unit 101 initiates a money transfer from buyer 108 to seller 107 and publishes the answer to the buyer 108. Finally, the central control unit 101 provides a short questionnaire to the buyer 108 that queries the buyer's final assessment of the provided answer and updates seller's and buyer's profiles in database 102.

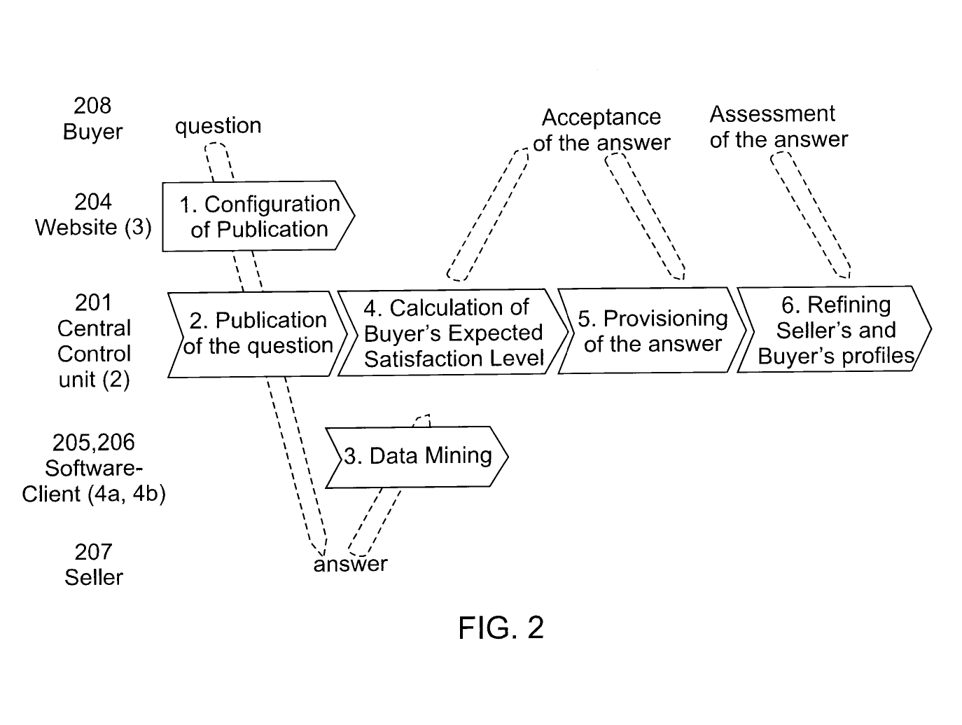

FIG. 2 shows a block diagram illustrating an example process for buying information supported by an embodiment of the claimed method. A buyer 208 is a person who wants to pose a question and wants to get an answer from a respective seller 207 for a specific price. Therefore, the buyer 208 poses his question on a website 204 which is in direct communication contact with a central control unit 201. The central control unit 201 is connected with at least one client unit 205 and 206. The client units 205, 206 are accessible, respectively, by the seller 207 via a suitable device. Such device can be, for example, a PC or a smartphone.

In step 1, the buyer 208 poses his question on the website 204 and, in step 2, the central control unit 201 posts and publishes the question on the website 204 and on client units 205, 206 of the registered seller 207. The seller 207 can then answer the question via his respective client units 205, 206. The client units 205, 206 analyse the seller's drafted answer by means of data mining prior to its publication to the buyer 208 as indicated in step 3. In step 4, the central control unit 201 calculates the buyer's satisfaction level taking into account the analysis result of the drafted answer. The central control unit 201 further communicates this calculated expected satisfaction level as processed analysis result to the buyer 208. If the buyer 208 accepts the offered answer, the central control unit 201 publishes, in step 5, the answer to the buyer 208 and further initiates a money transfer from buyer 208 to seller 207. Further, the central control unit 201 provides a short questionnaire to the buyer 208 that queries the buyer's final assessment of the provided answer. The buyer 208 gives his assessment of the answer and, based on this assessment, the seller's and buyer's profiles are refined in step 6, and updated by the central control unit 201 and the updated profiles are stored in a database not shown here.

The seller 207 may deliver the buyer 208 an inside into the answer to a certain degree without publishing the content. The seller 207 enters his answer into a respective client unit 205, 206 and initializes a data mining function on the client unit 205, 206. The client unit 205, 206 may check then, for example, a syntax as, for example, a number of sentences, a number of words and a number of special terms like weblinks. Furthermore, the software client or client unit may check the content of the answer as, for example, words and phrases that are desired (white list) and/or not desired (black list) by the buyer, words and phrases that other sellers use in their answers to the same question, words and phrases that have been used in already assessed answers within the same special field, and words and phrases that are available in the Internet within the same special field. Furthermore, the client unit may check a chronology, that means a number of entered and maybe deleted words mapped over the time. The client unit may conclude and communicate following information to the buyer:

extend and complexity of the drafted answer,

conformity with wording used by a comparable seller.

The central control unit 201 maintains a list of terms that are seen as relevant within a special field. These terms can be automatically read out of answers that have been possibly assessed within the inventive system and of professional internet articles within the same special field. The terms can also be confirmed, devaluated or newly created by a buyer.

The client unit may communicate to the buyer how many relevant terms the current drafted answers contain compared to answers to the current question that have been offered or already accepted and/or old answers that have been valued above a certain level.

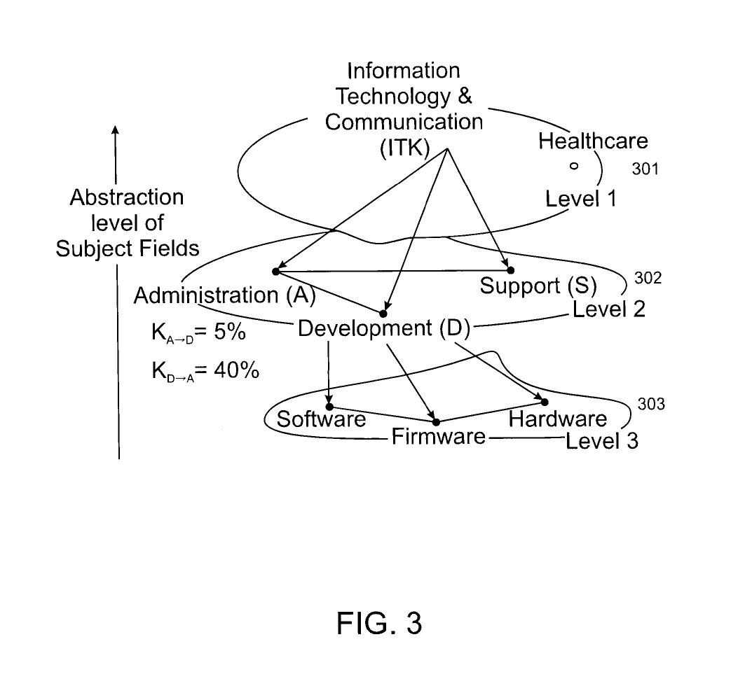

FIG. 3 depicts an example directed graph describing an example correlation of subject fields. Subject fields of a seller within an embodiment of the claimed system are hierarchically related to each other. They are ranging from rather general fields on the top to rather special fields at the bottom. The subject fields are also correlated crosswise regarding a relevance that knowledge in field A means for having knowledge in field B. The degree of correlation may be expressed by a coefficient k_{A→B}, reaching from 0 to 100%. The same coefficient may also be used in the data mining process for calculating an importance of words and phrases in field A for field B.

FIG. 3 shows an example of subject fields assigned to different levels of abstraction and correlated to each other. FIG. 3 shows three different abstraction levels of subject fields. The first level 301 is the most abstract level and comprises as subject fields “information, technology and communication (ITK)” and “healthcare”. The second level 302 comprises subject fields “administration (A)”, “development (D)” and “support (S)”. The third level 303 comprises subject fields of “software”, “firmware” and “hardware”. The first level 301, particularly the subject field “information, technology and communication” is connected with the second level 302 via bold arrows. That means, that the subject fields “administration”, “development” and “support” can also be subsummed under the subject field “information technology and communication”. Furthermore, the third level 303 is connected with the second level 302 by further bold arrows which means, that the subject field “development” comprises the subject fields “software”, “firmware” and “hardware”. The subject fields within one level, shown here in the second level 302 are correlated with each other which is indicated by slight arrows. As shown here, there is a correlation between the subject field “administration (A)” and the subject field “development (D)”.

This correlation is indicated by the already mentioned coefficient k_{A→D} and expressed here as 5%. A further correlation exists between the subject field “administration” and the subject field “support” which is expressed by a coefficient k_{A→B}=x %. The coefficient k_{A→D} of 5% expresses the expectation that someone with, for example, 80% knowledge in “administration” has in average 80%×5%=4% knowledge in “development”.

The correlation between the subject field is initially estimated and then corrected by an aggregation of the seller's profiles. Subject fields may also be newly created by a buyer while defining subject fields in a question's profile.

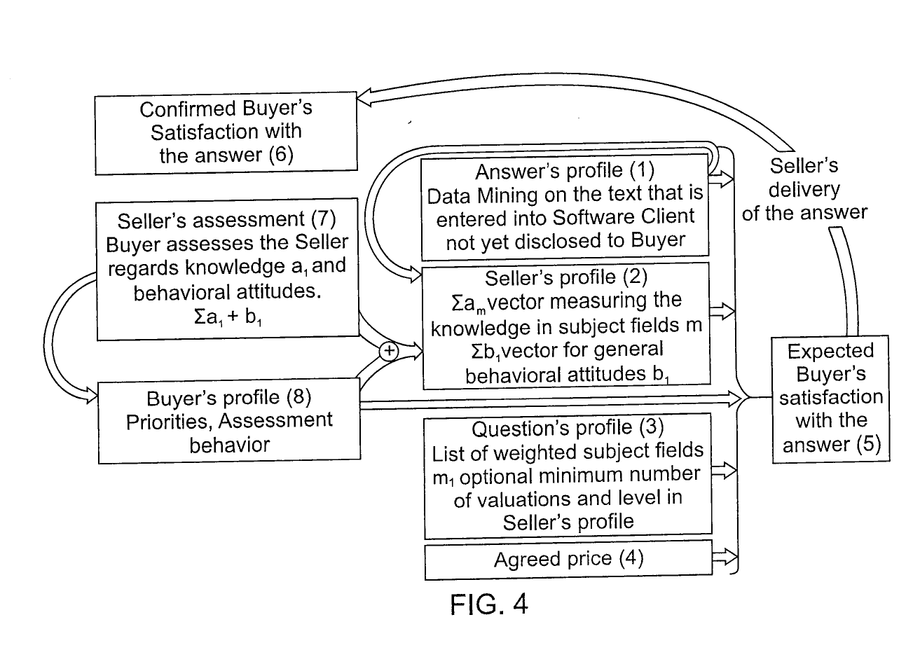

FIG. 4 shows an example cycle of calculating a buyer's expected satisfaction level by processing a data mining analysis result and a comparison of a seller profile and a buyer's profile. Those profiles are stored in a database which is accessible by a central control unit as a part of the claimed system.

In block 1, the seller has entered a draft answer in a respective client unit, the answer is not yet delivered or published. The answer is then automatically analysed by the client unit by means of data mining. The result is used to calculate an expected buyer's satisfaction and to update a respective profile of the seller. The expected buyer's satisfaction is indicated by block 5. The seller's profile is updated in block 2. The seller's profile, according to block 2, comprises an expert knowledge of the seller in certain subject fields m, for example, in “website programming”, “mobile app programming” and “payment processing”. Furthermore, the seller's profile also comprises behavioural attitudes bⱼ like reliability. The levels in knowledge and behavioural attitudes are specified as percent, for example 80% or 110%. The community that is considered in that regard consists of sellers assigned to subject fields that are directly or by coefficients k_{AB} related to the subject fields which have been selected by an actual buyer.

In block 8, it is indicated that a profile of an actual buyer stores past requirements and assessment behaviour of the buyer.

Block 3 indicates a profile of the question stated by the buyer. The question's profile states which knowledge fields and attitudes the buyer regards as relevant for solving the question to his satisfaction. The buyer may also weight each knowledge field and attitude for its importance for the solution of the question. The question's profile may also include a minimum amount of valuations and knowledge levels that a seller has to achieve before getting the permission to answer.

A price that is agreed for a requested information between buyer and seller as indicated in block 4 may influence the calculated expected buyer's satisfaction, as indicated in block 5. The higher the price the lower the expected satisfaction level.

The expected buyer's satisfaction, as indicated in block 5, is stochastically regressed from the preceding five predictors, namely block 1, 2, 8, 3 and 4, as indicated by the respective arrows and the curly brace. The expective buyer's satisfaction is further regressed from the respective coefficient and is finally compared to the confirmed buyer's satisfaction, as indication by block 6. The coefficients may be continuously adjusted upon the comparison with the confirmed buyer's satisfaction. The quality of the whole inventive assessment system is determined by the correlation of the values of the expected buyer's satisfaction (block 5) and the confirmed buyer's satisfaction (block 6).

Upon information delivery, the buyer may also rate the seller's compliance, as indicated in block 7, with criteria that he has previously set in the question's profile (block 3). An impact of the buyer's rating on the seller's profile depends on the buyer's profile. If the buyer in average rates sellers higher or lower than other buyers do for the same sellers, then the buyer is regarded to be in general more generous or stingy than the average. The buyer's rating of a seller is normalized accordingly before the seller's profile is refined by that rating.

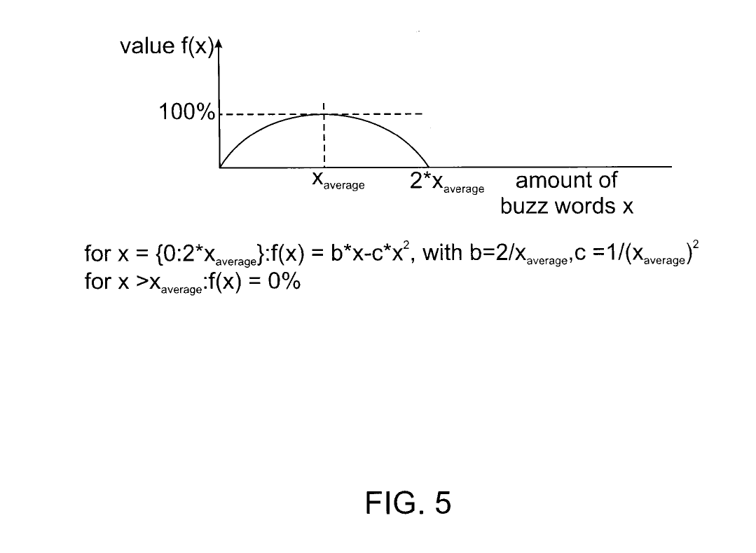

FIGS. 5, 6 and 7 describe a detailed example of how to calculate a buyer's expected satisfaction according to an embodiment of the claimed method.

The shown example excludes a price as predictor for a buyer's expected satisfaction. In the shown implementation, the expected value concerns a quality of an offered answer. The buyer needs to judge by himself, whether the quoted price matches the expected quality.

The buyer's expected satisfaction is given by the following formula:

buyer's expected satisfaction={[match between question and seller profile]×[weight of match]}+{[assessment of entered answer]×[weight of answer assessment]}.

The process is explained by the following fictive story. A head of development of a software company, named [A], and his team are not able to get rid of a graphical defect on a developed website. [A] enters a question on a knowledge portal, particularly on a web portal and, thereby, selects and weights certain subject fields. One subject field needs to be chosen as a main field and weighted by at least 50%. [A] judges that the current question may by 50% be solved with website graphics knowhow, by 30% with Microsoft Internet information server knowhow and by 20% with C++ programming knowhow. [A] sets a basis price for an answer to 50 USD. But in the current example, the price is not included in the calculation of the expected satisfaction value.

A software developer, named [B] has already answered several questions on the web portal, named here MindCash and, thereby, built up his profile from various customer valuations. [B]'s profile shows 95% customer satisfaction in the subject field “MS IIS” and 110% customer satisfaction in “C++ programming”. If the customer is extraordinarily satisfied, he may exceed the satisfaction value of 100%. A maximum value is 120%. In the subject field, “web site graphics” [B] did not yet collect any customer feedback.

For the calculation of the expected buyer's satisfaction, the shown embodiment of the claimed system provisionally estimates [B]'s knowledge in “web site graphics” by viewing profiles of other experts of the web portal with similar profiles that also cover the subject field “web site graphics”. The system carefully takes the customer satisfaction value of an expert who is less productive than the average, being among the best 70%. In the current case, the system assumes a satisfaction value of 60% for subject field “web site graphics” for [B].

The match between question and seller profile is calculated as follows:

Σ(weight of subject field according to question's profile)×(seller's profile value for that subject field) as the sum over all relevant subject fields.

In the current example, the sum is

{[weight of “web site graphics”=50%]×[B's profile value in that field=60%]}+{[weight of “MS IIS”=30%]×[B's profile value in that field=95%]}+{[weight of “C++ programming”=20%]×[B's profile value in that field=110%]}=80.5%.

A client unit as a part of the claimed system is automatically performing the data mining process on an inserted, but not yet forwarded, answer stated by a respective seller.

For each subject field, the client unit has a list of buzz words locally stored on the client device which can be, for example, a PC or a smartphone. The client unit checks to which extend the buzz words occur in [B]'s entered, not yet forwarded, answer. In the current fictive example, the client unit finds seven matches. One in the field of “web site graphics”, five in the field of “MS IIS” and one in the field of “C++ programming”.

It is also possible that the data mining method also considers buzz words from other subject fields than those which have been chosen by the buyer if these buzz words occur with a probability of higher than, for example, 50% in the context of the chosen main subject field.

[B]'s answer is 150 digits long, whereas answers concerning questions in the field “web site graphics” are in average just 100 digits long.

Answers to recent questions within the same subject field “web site graphics” do in relation to the text size of 150 digits in average contain 2.3 registered buzz words from field of “web site graphics”, 1.2 buzz words from “MS IIS” and 1.1 buzz words from “C++ programming”.

The assessment of an entered answer is calculated as follows:

[assessment of the entered answer]={[assessment of the buzz words]×[weight of buzz word assessment]}+{[assessment of the answer's length]×[weight of length assessment]}.

The assessment of the buzz words is calculated as follows. A seller achieves the highest value if he uses as much buzz words as other experts have in average used in comparable tasks. Using less or more buzz words than the average is regarded as unprofessional to some extend and devaluates the assessment value.

FIG. 5 shows the used function. On the ordinate, the value of the function f(x) is indicated in units percent. On the abscissa, an amount of buzz words x is indicated. The function f (x) is defined as follows:

for x=[0,2*x_{average}]:f(x)=b*x−c*x², with b=2/x_{average},c=1/(x_{average})²

for x>2*x_{average}:f(x)=0%

In the current fictive example, the assessment of the buzz words is defined as follows:

[assessment of the buzz words]={[2/2.3)*1-(1/2.3)²)*1²}*50%+0*30%+{(2/1.1)*1−(1/(1.1)²)*1²}*20%=53.9%.

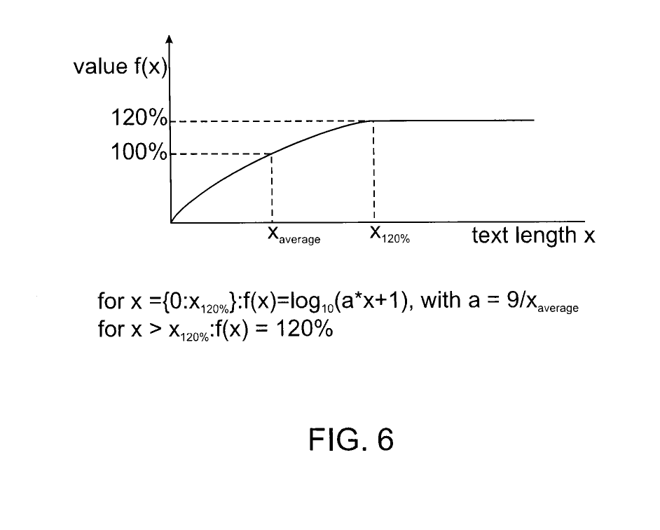

The assessment of the answer's text length is calculated as follows. The value increases logarithmically with the length of the text, but does not overexceed the value of 120% which corresponds to the general maximum satisfaction value. The used function is shown in FIG. 6. The function is defined as follows:

for x=[0,x_{120%}]:f(x)=log₁₀(a*x+1), with a=9/x_{average}

for x>x_{120%}:f(x)=120%.

In the current fictive example, the [assessment of the answer's text length]=log₁₀ ((9/100)*150+1)=116%.

With an assumed [weight of the buzz word assessment] of 60% and [weight of text length assessment] of 40% the [Assessment of the entered Answer] is (53.9%*60%)+(116%*40%)=78.7%.

With an assumed [weight of the match between the question and seller profile] of 60% and [weight of answer assessment] of 40% the [buyer's expected satisfaction] is (80.5%*60%)+(78.7%*40%)=79.8%.

According to the level of significance of the seller's profile coming from the amount and variety of collected customer valuations, that significance has an effect on the probability of error in the expected satisfaction. In order to keep the result plain for the buyer, the displayed expected satisfaction result may be enriched by a statement about the stability of the estimation. If the seller's overall profile significance in the considered subject fields is clearly higher than the average in the considered fields, then the stability value is low. If the seller's significance is all about the average, then the stability value is medium. If the seller's significance is clearly lower than the average, then the stability value is high.

After receipt of the answer, the buyer is motivated to rate the seller. If the buyer refuses to rate the seller, then the absence of rating is irreversibly reported in the buyer's profile. Such notice means a disadvantage for the buyer for motivating sellers to answer on further questions, because aspect of building up their profile and, thereby, enhancing their market value is probably an important aspect for the sellers and the seller might see a risk for improving his profile with a buyer that may not rate him.

The knowledge portal as part of the inventive system asks the buyer to enter or choose a value for his overall satisfaction and for his satisfaction with the seller's knowhow in the chosen subject fields.

Weighted by money that was spent in the recent deal relatively to money that was in total spent in the seller's cumulative previous deals and weighted by the buyer's general valuation habit relatively to the average of other buyers, the seller's profile in the regarded subject fields is updated. In the current fictive example, [B]'s profile in the fields of “web site graphics”, “MS IIS” and “C++ programming” is updated and strengthened.

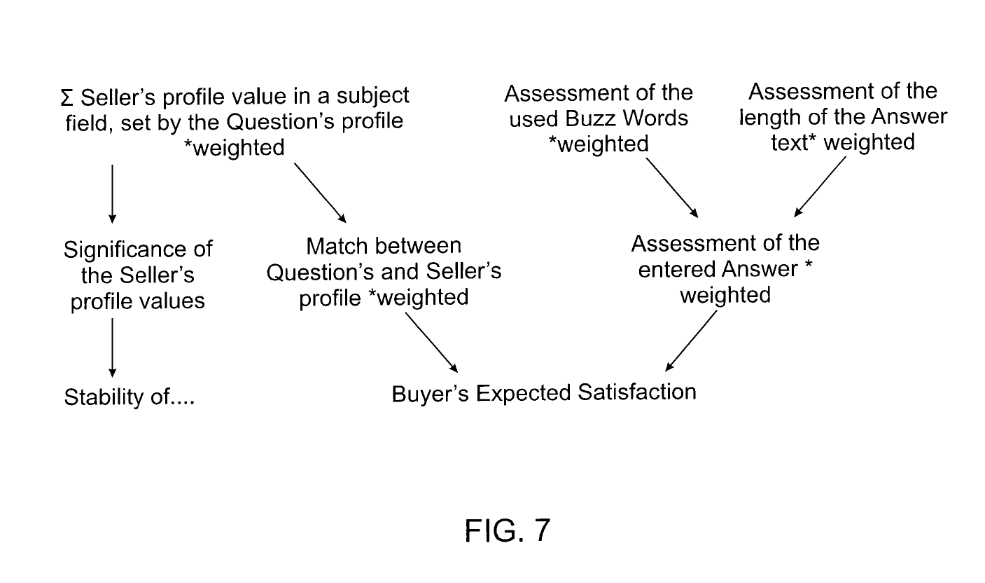

The whole process of calculating the buyer's expected satisfaction together with the stability of that hypothesis is shown in FIG. 7.

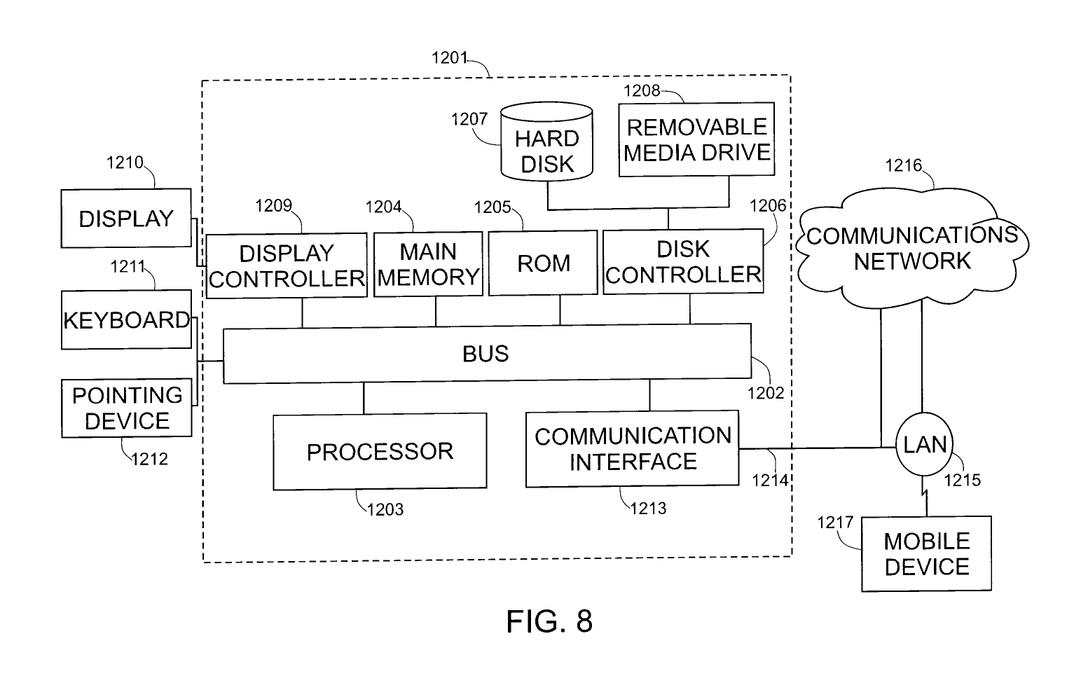

FIG. 8 illustrates a computer system 1201 upon which an embodiment of the present invention may be implemented. The computer system 1201 includes a bus 1202 or other communication mechanism for communicating information, and a processor 1203 coupled with the bus 1202 for processing the information. The computer system 1201 also includes a main memory 1204, such as a random access memory (RAM) or other dynamic storage device (e.g., dynamic RAM (DRAM), static RAM (SRAM), and synchronous DRAM (SDRAM)), coupled to the bus 1202 for storing information and instructions to be executed by processor 1203. In addition, the main memory 1204 may be used for storing temporary variables or other intermediate information during the execution of instructions by the processor 1203. The computer system 1201 further includes a read only memory (ROM) 1205 or other static storage device (e.g., programmable ROM (PROM), erasable PROM (EPROM), and electrically erasable PROM (EEPROM)) coupled to the bus 1202 for storing static information and instructions for the processor 1203.

The computer system 1201 also includes a disk controller 1206 coupled to the bus 1202 to control one or more storage devices for storing information and instructions, such as a magnetic hard disk 1207, and a removable media drive 1208 (e.g., floppy disk drive, read-only compact disc drive, read/write compact disc drive, compact disc jukebox, tape drive, and removable magneto-optical drive). The storage devices may be added to the computer system 1201 using an appropriate device interface (e.g., small computer system interface (SCSI), integrated device electronics (IDE), enhanced-IDE (E-IDE), direct memory access (DMA), or ultra-DMA).

The computer system 1201 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system 1201 may also include a display controller 1209 coupled to the bus 1202 to control a display 1210, such as a cathode ray tube (CRT), for displaying information to a computer user. The computer system includes input devices, such as a keyboard 1211 and a pointing device 1212, for interacting with a computer user and providing information to the processor 1203. The pointing device 1212, for example, may be a mouse, a trackball, or a pointing stick for communicating direction information and command selections to the processor 1203 and for controlling cursor movement on the display 1210. In addition, a printer may provide printed listings of data stored and/or generated by the computer system 1201.

The computer system 1201 performs a portion or all of the processing steps of the invention in response to the processor 1203 executing one or more sequences of one or more instructions contained in a memory, such as the main memory 1204. Such instructions may be read into the main memory 1204 from another computer readable medium, such as a hard disk 1207 or a removable media drive 1208. One or more processors in a multi-processing arrangement may also be employed to execute the sequences of instructions contained in main memory 1204. In alternative embodiments, hard-wired circuitry may be used in place of or in combination with software instructions. Thus, embodiments are not limited to any specific combination of hardware circuitry and software.

As stated above, the computer system 1201 includes at least one computer readable medium or memory for holding instructions programmed according to the teachings of the invention and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes, a carrier wave (described below), or any other medium from which a computer can read.

Stored on any one or on a combination of computer readable media, the present invention includes software for controlling the computer system 1201, for driving a device or devices for implementing the invention, and for enabling the computer system 1201 to interact with a human user (e.g., print production personnel). Such software may include, but is not limited to, device drivers, operating systems, development tools, and applications software. Such computer readable media further includes the computer program product of the present invention for performing all or a portion (if processing is distributed) of the processing performed in implementing the invention.

The computer code devices of the present invention may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

The term “computer readable medium” as used herein refers to any medium that participates in providing instructions to the processor 1203 for execution. A computer readable medium may take many forms, including but not limited to, non-volatile media, volatile media, and transmission media. Non-volatile media includes, for example, optical, magnetic disks, and magneto-optical disks, such as the hard disk 1207 or the removable media drive 1208. Volatile media includes dynamic memory, such as the main memory 1204. Transmission media includes coaxial cables, copper wire and fiber optics, including the wires that make up the bus 1202. Transmission media also may also take the form of acoustic or light waves, such as those generated during radio wave and infrared data communications.

Various forms of computer readable media may be involved in carrying out one or more sequences of one or more instructions to processor 1203 for execution. For example, the instructions may initially be carried on a magnetic disk of a remote computer. The remote computer can load the instructions for implementing all or a portion of the present invention remotely into a dynamic memory and send the instructions over a telephone line using a modem. A modem local to the computer system 1201 may receive the data on the telephone line and use an infrared transmitter to convert the data to an infrared signal. An infrared detector coupled to the bus 1202 can receive the data carried in the infrared signal and place the data on the bus 1202. The bus 1202 carries the data to the main memory 1204, from which the processor 1203 retrieves and executes the instructions. The instructions received by the main memory 1204 may optionally be stored on storage device 1207 or 1208 either before or after execution by processor 1203.

The computer system 1201 also includes a communication interface 1213 coupled to the bus 1202. The communication interface 1213 provides a two-way data communication coupling to a network link 1214 that is connected to, for example, a local area network (LAN) 1215, or to another communications network 1216 such as the Internet. For example, the communication interface 1213 may be a network interface card to attach to any packet switched LAN. As another example, the communication interface 1213 may be an asymmetrical digital subscriber line (ADSL) card, an integrated services digital network (ISDN) card or a modem to provide a data communication connection to a corresponding type of communications line. Wireless links may also be implemented. In any such implementation, the communication interface 1213 sends and receives electrical, electromagnetic or optical signals that carry digital data streams representing various types of information.

The network link 1214 typically provides data communication through one or more networks to other data devices. For example, the network link 1214 may provide a connection to another computer through a local network 1215 (e.g., a LAN) or through equipment operated by a service provider, which provides communication services through a communications network 1216. The local network 1214 and the communications network 1216 use, for example, electrical, electromagnetic, or optical signals that carry digital data streams, and the associated physical layer (e.g., CAT 5 cable, coaxial cable, optical fiber, etc). The signals through the various networks and the signals on the network link 1214 and through the communication interface 1213, which carry the digital data to and from the computer system 1201 maybe implemented in baseband signals, or carrier wave based signals. The baseband signals convey the digital data as unmodulated electrical pulses that are descriptive of a stream of digital data bits, where the term “bits” is to be construed broadly to mean symbol, where each symbol conveys at least one or more information bits. The digital data may also be used to modulate a carrier wave, such as with amplitude, phase and/or frequency shift keyed signals that are propagated over a conductive media, or transmitted as electromagnetic waves through a propagation medium. Thus, the digital data may be sent as unmodulated baseband data through a “wired” communication channel and/or sent within a predetermined frequency band, different than baseband, by modulating a carrier wave. The computer system 1201 can transmit and receive data, including program code, through the network(s) 1215 and 1216, the network link 1214 and the communication interface 1213. Moreover, the network link 1214 may provide a connection through a LAN 1215 to a mobile device 1217 such as a personal digital assistant (PDA) laptop computer, or cellular telephone.

1. A system for rating online offered information, the system comprising:
a central control unit,
at least one client unit of at least one seller, and
a knowledge portal,
wherein the central control unit is configured to receive via the knowledge portal a question stated by a buyer, and to post the question on the knowledge portal and optionally on the at least one client unit of the at least one seller, the at least one client unit is configured to analyse a drafted answer of the seller by use of data mining prior to publication of the answer and to send its analysis result to the central control unit which is further configured to process the analysis result and to communicate the processed analysis result to the buyer and to publish the answer to the buyer in case that the buyer accepts the answer based on the processed analysis result.

2. The system according to claim 1, wherein the knowledge portal is a website hosted on at least one web server accessible via the Internet or via a private local area network through an Internet address.

3. The system according to claim 1, wherein the knowledge portal is configured to request from the buyer to state the question, to assign the question to one or more selectable subject fields or to a new one, and to set a basis price for an answer.

4. The system according to claim 1 further comprising a database used to store seller, buyer and buyer's question profiles, respectively, and accessible by the central control unit.

5-14. (canceled)

15. The system according to claim 1 wherein the knowledge portal enables a function that reduces a basis price for the answer which is pregiven by the buyer as a function of time.

16-17. (canceled)

18. The system according to claim 1 wherein the central control unit is further configured to read out an ID of the at least one seller's hardware and to assign a temporary and anonymous ID to the at least one seller if the seller answers to the buyer's question prior to his registration at the system.

19. (canceled)

20. The system according to claim 1 wherein the processed analysis result is gained by calculating an expected satisfaction level of the buyer by taking into account the analysis result.

21. The system according to claim 1 wherein the client unit checks a syntax as a number of sentences, a number of words and/or a number of special terms like weblinks.

22. The system according to claim 1 wherein the client unit checks a content of the drafted answer as words and phrases that are desired and/or not desired by the buyer, words and phrases that other sellers use in their answers to the same question, words and phrases that have been used in already assessed answers within the same special field, and/or words and phrases that are available in the Internet within the same special field.

23. The system according to claim 1 wherein the client unit checks a chronology, that means a number of entered and maybe deleted words mapped over the time.

24. The system according to claim 1 wherein not only the drafted answer of the seller is analysed by use of data mining prior to publication of the answer, but also the seller and buyer's question profiles are compared with each other by the central control unit.

25. (canceled)

26. The system according to claim 6 wherein the match of the seller profile to the buyer's question profile is calculated by weighting according to the buyer's question profile the seller's profiled knowhow in the regarded subject fields and summing them up.

27. The system according to claim 1 wherein the central control unit is further configured, in case that the buyer wants to accept the answer of the at least one seller, to initiate a money transfer from buyer to seller prior to publishing the answer to the buyer.

28. (canceled)

29. The system according to claim 4 wherein the central control unit is further configured to update respective seller, buyer and buyer's question profiles in the database.

30. The system according to claim 29 wherein a seller profile is updated concerning his knowhow in a set of subject fields that are comprised in a concerning question profile.

31. (canceled)

32. The system according to claim 30 wherein a buyer's assessment of the answer is weighted by a ratio of a spent money amount for the regarded seller's answer to a money amount that the regarded seller has totally gathered, before the seller profile is updated.

33. A method for rating online offered information, the method comprising at least the following steps:
receiving a question stated by a buyer via a knowledge site;
posting the question on the knowledge site and optionally on at least one client unit of at least one seller;
analysing a drafted answer of the at least one seller at the least one client unit by using data mining prior to publishing the answer;
processing the analysis result;
communicating the processed analysis result to the buyer; and
publishing the answer to the buyer in case that the buyer accepts the answer based on the processed analysis result.

34. The method according to claim 33 wherein the knowledge site is chosen as a website hosted on at least one web server accessible via the Internet or via a private local area network through an Internet address.

35. The method according to claim 33, wherein the knowledge site requests from the buyer to state the question, to assign the question to one or more selectable subject fields or to a new one and to set a basis price for an answer.

36. The method according to claim 33 wherein seller, buyer and buyer's question profiles are stored at a database, respectively.

37-45. (canceled)

46. The method according to claim 33 wherein the knowledge site enables a function that reduces a basis price for the answer which is pregiven by the buyer as a function of time.

47-48. (canceled)

49. The method according to claim 33 wherein an ID of the at least one seller's hardware is read out and a temporary and anonymous ID is assigned to the at least one seller if the seller answers to the buyer's question prior to his registration at the system.

50. (canceled)

51. The method according to claim 33 wherein the processed analysis result is gained by calculating an expected satisfaction level of the buyer by taking into account the analysis result.

52. The method according to claim 33 wherein not only the drafted answer of the seller is analysed by use of data mining prior to publication of the answer, but also the seller and buyer profiles are compared with each other by the central control unit.

53. (canceled)

54. The method according to claim 33 wherein, in case that the buyer wants to accept the answer of the at least one seller a money transfer from buyer to seller prior to publishing the answer to the buyer, is initiated.

55-56. (canceled)

57. The method according to claim 33 wherein the client unit checks a syntax as particularly a number of sentences, a number of words and a number of special terms like weblinks.

58. The method according to claim 33 wherein the client unit checks a content of the drafted answer as words and phrases that are desired and/or not desired by the buyer, words and phrases that other sellers use in their answers to the same question, words and phrases that have been used in already assessed answers within the same special field, and words and phrases that are available in the Internet within the same special field.

59. The method according to claim 33 wherein the client unit checks a chronology, that means a number of entered and maybe deleted words mapped over the time.

60-61. (canceled)

62. The method according to claim 33 wherein a seller profile is updated concerning his knowhow in a set of subject fields that are comprised in a concerning question profile.

63. (canceled)

64. The method according to claim 62 wherein a buyer's assessment of the answer is weighted by a ratio of a spent money amount for the regarded seller's answer to a money amount that the regarded seller has totally gathered, before the seller profile is updated.

65. A system for rating online offered information, the system comprising:
a central control unit comprising a central server having a central memory storing server executable instructions and a central processor programmed with the executable instructions stored in the central memory,
at least one client unit of at least one seller comprising a seller memory storing client executable instructions and a seller processor programmed with the executable instructions stored in the seller memory, and
a knowledge portal in communication with the central control unit and the client unit,
wherein the central control unit is configured with the server executable instructions to receive via the knowledge portal a question stated by a buyer, and to post the question on the knowledge portal and optionally on the at least one client unit of the at least one seller, the at least one client unit is configured with the client executable instructions to analyse a drafted answer of the seller by data mining prior to publication of the answer and to send an analysis result to the central control unit which is further configured with the server executable instructions to process the analysis result and to communicate the processed analysis result to the buyer via the knowledge portal and to publish the answer to the buyer in case that the buyer accepts the answer based on the processed analysis result.

66. A method for rating online offered information, the method comprising at least the following steps:
receiving, on a server having a server processor, a question stated by a buyer via a knowledge site;
posting the question on the knowledge site and optionally on at least one client unit of at least one seller;
analyzing, in the server processor, a drafted answer of the at least one seller by data mining prior to publishing the answer;
processing, in the server processor, the analysis result;
communicating the processed analysis result to the buyer over a communications network; and
publishing the answer to the buyer in case that the buyer accepts the answer based on the processed analysis result.

67. A method for rating online offered information, the method comprising at least the following steps:
receiving, on a server having a server processor, a question stated by a buyer via a knowledge site;
posting the question on the knowledge site and optionally on at least one client unit of at least one seller, wherein the client unit has a client processor;
analyzing, in the client processor, a drafted answer of the at least one seller by data mining prior to publishing the answer;
processing, in at least one of the client processor and the server processor, the analysis result;
communicating the processed analysis result to the buyer over a communications network; and
publishing the answer to the buyer in case that the buyer accepts the answer based on the processed analysis result.
